(19) United States
(12) Patent Application Publication
(10) Pub. No.: US 2006/0184371 A1
(43) Pub. Date: Aug. 17, 2006

(54) Risk management

(76) Inventor: Chris Tsalakopoulos, Victoria (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/545,759

(22) PCT Filed: Feb. 19, 2004
(86) PCT No.: PCT/AU04/00197

§ 371 Date: Aug. 15, 2005

(30) Foreign Application Priority Data
Feb. 19, 2003 (AU) 2003902636

(51) Int. Cl. G06Q 99/00; G05B 19/418; G06F 9/46

(52) U.S. Cl. 705/1; 705/8

(57) ABSTRACT

A risk management process is provided that has steps of defining a risk by providing: (a) a descriptive title; (b) a risk impact value; and (c) a likelihood value. (a), (b), and (c) are then set as a first set of initial conditions for the risk. A node for the risk is then established with the first set of initial conditions associated therewith. Steps 1 and 2 are then repeated on a possible further risk. If the initial conditions obtained are not identical with the initial conditions of the node the descriptive titles are compared and if the descriptive titles are not identical, a further node is established with initial conditions determined for that possible further risk. If the descriptive titles are identical, both the impact values and the likelihood values are compared and if one of those impact or likelihood values is identical, the initial conditions of that possible further risk are associated with the risk node. If neither of the impact values and likelihood values is identical, then an additional risk node is established with the initial conditions for that risk as initially determined for that possible further risk. The established nodes permit identification of the risks, and the subsequent tracking of the risks.

### FIELD OF THE INVENTION

This invention relates to risk management and relates particularly but not exclusively to a computerised process for managing a plurality of risk events over time. The process may be applied manually without computer assistance, however, it is particularly preferred that the invention be implemented in a computer environment.

### DESCRIPTION OF PRIOR ART

Organisations such as large government instrumentalities that provide public services have involved risk management processes to manage the risk environment in which the organisation is operating. Risk management processes are not unique or confined to large government instrumentalities. Typically, a risk environment for an organisation is dynamic, interrelated and complex. Typically an organisation will be exposed to many threats and uncertainties in its day to day operations. These threats/uncertainties interrelate in many complex and unknown or unpredictable ways. Accordingly, the management of a risk environment for an organisation is very complex and difficult to profile and track over time.

Current methods and approaches to identifying risks work on the assumption that risks are simple self-contained objects with clear boundaries that separate them from non-risk aspects of an environment. Therefore, under this belief, identifying risks is simply a process of finding or spotting them within an environment/situation, as if one were to sift through a plate of wheat and pick out and remove the bad seeds.

This conception of risk has worked well historically because the concept of risk was applied to situations where identifying and classifying risks were easy. For example we can easily identify the (downside) risk in a game of chance. This is simply the product of the amount I bet and the odds of losing that amount. We can easily achieve a clear, unambiguous definition of risk for this situation. Similarly, in the fields of finance and insurance, the simple approach to identifying risks is also applied successfully. This is because fixed categories of risk are easy to establish, such as interest rate risk and commodity price risk. These risks have clear static boundaries and meanings.

However, when we move out of these highly structured environments into complex human system environments, such as the systems of interaction that occur within an organisation, identifying risk under the traditional concepts and approaches becomes highly problematic.

The problematic nature of current risk identification approaches can be understood through the fundamental characteristics of human systems. Human systems are highly complex chaotic systems; they are extremely difficult to map and it is impossible to predict how the interactions will evolve into the future. Risk is a human experience. If humans are not present, there is no risk. Human interaction is a form of human experience. Therefore, risk is closely tied to the interactions in human systems. It then follows that risk will exhibit the same complex chaotic patterns as the human interactions it is derived from.

For example, lets look at the human system interactions at a procurement department within an organisation. Lets assume it is responsible for managing suppliers and ensuring timely delivery of key supplies that are used by the organisation to produce an end product. Even though there are standards and procedures in place to govern the interactions, on a day-to-day basis, there is a virtual infinite array of interactions, events and situations that could unfold in unpredictable ways. Therefore, since risk is tied to these interactions (experiences), pre-defining or classifying (in other words identifying) the risks in this area becomes an almost impossible exercise.

If for example we define a ‘supplier risk’ (e.g. a significant disruption to key supplies), it is unclear what is contained within this definition, and what is outside the definition. We have no clear boundaries that can be used to state, “this is ‘suppler risk’, and that is XYZ risk.”

Can a potential strike at a distribution route between the supplier and our organisation, be defined as ‘supplier risk’, bearing in mind that the type of disruption to supplies it may cause is different in some way from what might have been initially understood as ‘supplier risk’? What about a legal threat to the supplier (from another organisation), which may cause a disruption to supplies, but also may cause a legal issue for us; is this also defined under ‘supplier risk’ or is it another risk? What about a solvency risk or cash flow risk to our organisation that stems from a shortage of supplies (that is, a shortage of supplies causes shortage of goods to sell, which intern causes a shortage of cash coming in the door); is this supplier risk, is it cash flow risk, or is it something else?

It is quite simple to go on for a short while and build up a complex mesh of risks that seem to overlap, interconnect and basically confuse and blur the lines of definition. It then becomes extremely difficult to identify, sort, assess, and collate these risks in simple and meaningful ways.

Other approaches that may try to overlook this ‘mesh of risks’ and instead concentrate on looking at business continuity planning (BCP) in case of disruption (whatever form the disruption may be) are producing BCPs with potentially significant gaps in their treatment plans. Whatever BCP is developed, it still needs to take account of the types of possible failures (therefore risks) that can occur; otherwise the contingency plans may not be suitable. Therefore, we have returned back to the initial problem of identifying and defining risks.

The key problem is that human systems are highly complex chaotic systems, and using the current simplistic and unstructured methods for identifying risks is a poor way to represent risk in these systems.

The simplistic and unstructured way we identify risks also creates critical gaps in any picture we attempt to build of the risk ‘terrain’ faced by an organisation. Because the risks faced by an organisation are complex and multi-layered, under a traditional approach to identifying risks we will often miss some of the key ‘perspectives’ and ‘layers’ of risks. The simplistic unstructured methods for identifying will tend to encourage us to look for simple, orderly categories of risks, such as supplier risk, reputation risk, theft risk, safety risk, etc. The significant danger here is that once risks are identified under these approaches, people will subconsciously stop perceiving other perspectives and variations on an identified risk.

For example we may identify a ‘supplier risk’ to the organisation, into which all supplier related risks are captured. This category will then tend to dictate our perception and thinking about ‘supplier’ risks. That is we will stop seeing subtle, but potentially critical variations and nuances of ‘supplier’ risk because they won't fit into the simple definition of suppler risk, nor will they fit into other adjacent definitions/category of risk. Therefore, they ‘slip through the cracks’. We now get to the situation of ‘out of sight out of mind’. Therefore critical and important risk ‘perspectives’ are hidden from the organisation's radar, until it's too late.

### OBJECT AND STATEMENTS OF THE INVENTION

There is a need for a process that identifies and tracks risk exposures within an environment that may be complex and dynamic.

Therefore according to a first broad aspect of the invention, there may be provided a risk management process for identification and tracking of a plurality of risks, said management process having at least the following steps:
1. defining a risk by providing:
   (a) a descriptive title;
   (b) a risk impact value; and
   (c) a likelihood value
2. setting (a), (b), and (c) as a first set of initial conditions for the risk;
3. establishing a node for the risk with the first set of initial conditions associated therewith;
4. repeating steps 1 and 2 on a possible further risk;
5. determining if the initial conditions obtained in step 4 are identical with the initial conditions of the node established in step 3; and if the initial conditions are not identical, comparing the descriptive titles and
   (i) if the descriptive titles are not identical, establishing a further node with initial conditions determined at step 2 for that possible further risk or
   (ii) if the descriptive titles are identical, comparing both the impact values and the likelihood values and
      (a) if one of those impact or likelihood values is identical, associating the initial conditions of that possible further risk with the risk node established at step 3 as a further initial condition; and
      (b) if neither of the impact values and likelihood values is identical, establishing an additional risk node with the initial conditions for that risk as determined at step 2 for that possible further risk.

Whereby the established nodes permit identification of the risks, and the subsequent tracking of the risks.

Preferably, the processes is repeated with possible further risks, and step (5) is performed by comparing the initial conditions of the possible further risks with the initial conditions of all nodes that exist at that time.

Most preferably the descriptive title in step (1) is defined by three descriptive title sub sets being:
(i) Type
(ii) Location and
(iii) Source

Preferably step 5(ii) requires all three sub sets to be identical, before the step of comparing both the impact values and the likelihood values results in either the association as in step 5(ii)(a) or establishing of a further risk node as in step 5(ii)(b).

Preferably when one or more associated further initial conditions are established for a risk node, a step of changing the overall risk values in that node is performed so that a changed overall risk value then assumes the risk value of the initial condition that has the higher of the impact value or the likelihood value.

Preferably if a third risk is attempted to be associated with a risk node and one of the impact values or likelihood values does not correspond with one or both of the established initial conditions for that node, then there is either performed the step of:

establishing a new risk node with the initial conditions for that new risk node being the initial conditions of the third risk, or the step of

disassociating an initial condition of one of the two initial conditions established for the risk node, and establishing a new risk node so that a new risk node has both the initial condition of the disassociated initial condition and the initial condition of the third risk associated therewith, and wherein either the impact values or the likelihood values of those two initial conditions agree with each other for that new risk node.

Preferably there is also provided the step of re-assessing risk values of an initial condition of a node, said re-assessing then being based on a changed initial condition, and wherein following a re-assessment
(i) if the impact value nor the likelihood value agree with the previous values then establishing a further new node with initial conditions of the re-assessed risk whilst leaving the original risk node with an associated initial condition that has not been changed consequent on the re-assessment.

Preferably if following re-assessment there is a match of either the impact value or the likelihood value, then the overall risk node value for the node is re-established based on the changed initial condition.

Preferably there is also provided the further step of applying a treatment to an existing node, said treatment affecting either or both the impact value and/or the likelihood value of the overall risk value of the existing node, and wherein if the treatment is to affect the impact value, causing the resulting impact value to assume a value determined by the difference between the impact value of the overall risk value of that node and the impact value of the treatment,

and wherein if the treatment is to affect the likelihood value, causing the resulting likelihood value of the overall risk value to assume a value determined by the likelihood value of the treatment.

Preferably there is also provided the further step of providing multiple treatments to a risk node and wherein each treatment follows the rules stated previously for affecting the impact value or the likelihood value of the overall risk value.

If required a single treatment may have multiple levels that may be individually activated.

Preferably, each level may be sequenced within the treatment.

Further, each level may be non-sequenced.

Preferably for sequenced treatments, the overall risk value is cumulatively adjusted for the impact value and assumes the likelihood value of the current treatment level.

Preferably for non-sequenced treatments, the overall risk value is represented by the treatment values of the current treatment level.

According to an even further aspect of the present invention, there is provided a computer system programmed to operate in a way to perform the process steps recited previously.

In accordance with a further broad aspect of the present invention, there is provided a memory medium containing data that will cause a computer system to be programmed to operate according to the process steps previously recited.

### BRIEF DESCRIPTION OF THE DRAWINGS

In order that the invention can be more clearly ascertained, one example will now be described with reference to the accompanied drawings for use in an electrical power distribution environment. The invention has application to an organisation performing any function where there are risks. It is not to be considered limited to an electrical power supply environment for example. In the drawings:

FIG. 1 is a diagram showing an example of a plurality of risk nodes, initial conditions attached to the nodes, and risk treating activities applied to the nodes, in accordance with the example.

FIGS. 2 and 3 are functional flow diagrams showing creation of risk nodes'.

FIGS. 4 through 34 are diagrams explaining nodes and initial conditions and treatments,

FIG. 35 is a functional flow diagram of the total process of the example, and

FIG. 36 is a diagram showing changes in risk, and a notification that a treatment of the risk may need re-assessment.

Typically an organisation will be exposed to many threats and uncertainties in its day to day operations and as it attempts to realise opportunities and meet its goals and objectives.

These underlying threats and uncertainties are not static and will change or evolve in unpredictable non-linear ways. An organisation will also react to these threats and uncertainties in a variety of ways, therefore adding further complexity to how the threats and uncertainties change and evolve. All this amounts to creating a very complex and dynamic risk environment which any (large) organisation must face. Accordingly, the problem faced by organisations is how to identify and track its risk exposures over time and in an effective manner.

In the present invention, a node is created which represents a possible risk. Risk nodes will capture an overall value (risk exposure levels such as impact and likelihood) from attached initial conditions and treatments which are sources of risk information about the risk situation the risk node is representing.

The sources of risk information represent data/information or knowledge on activities and experiences of the organisation that relate to risk situations the organisation may be facing.

In the example to be described hereinafter, there are two types of risk information. These are:
(1) initial conditions; and
(2) treating activities

An initial condition is risk information that may come from an assessment performed specifically for a pre-defined risk, or other sources of information such as a general assessment not necessarily performed for a specific risk.

‘Initial condition’ is risk information (and risk values) about a risk, but does not include any risk information about any treating activity that may be currently applied to that risk. The key defining aspect of ‘initial condition’ risk information is that the risk values (e.g. impact and likelihood) do not include any data from any currently applied treatment or yet to be applied treatment to the risk.

Therefore if a treatment has been applied to a risk, and becomes a permanent fixture in the environment of the risk, and is no longer regarded as an activity that is currently treating the risk, then it can be included in any subsequent initial condition risk information values for that risk.

A treating activity can be any action that is designed to mitigate the risk in some way (this is a standard concept in risk management). The mitigation will in someway involve the lowering (or in some cases the complete removal) of the risk exposure levels (i.e. the risk values). Importantly, any risk values that are used in the treating activity risk information must not also be part of any initial condition risk values used for that risk node. The risk node becomes the central point at which the effects of the activities of the risk treatment adjust the current overall risk value (impact and likelihood) for that risk node.

Accordingly, a node is created with a descriptive title and at least one initial condition. An initial condition comprises an impact value and a likelihood value for the particular risk. Thus, for a node, there are three risk components being:
(i) a descriptive title;
(ii) impact value; and
(iii) likelihood value.

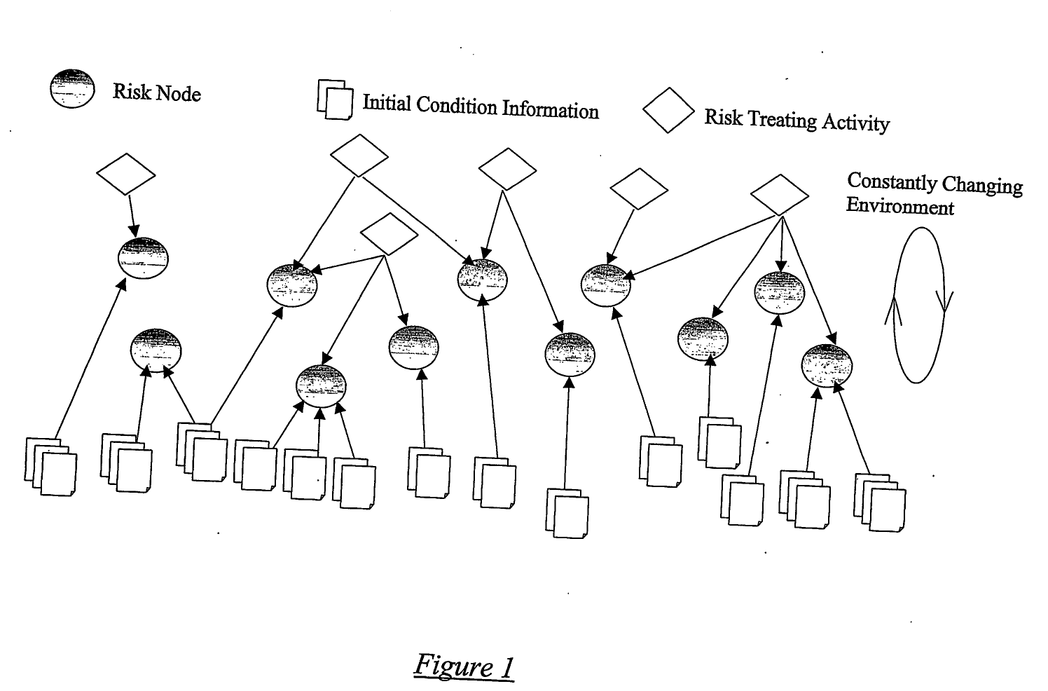

FIG. 1 shows the relationship of each of the nodes with associated initial conditions and treatments applied to the nodes.

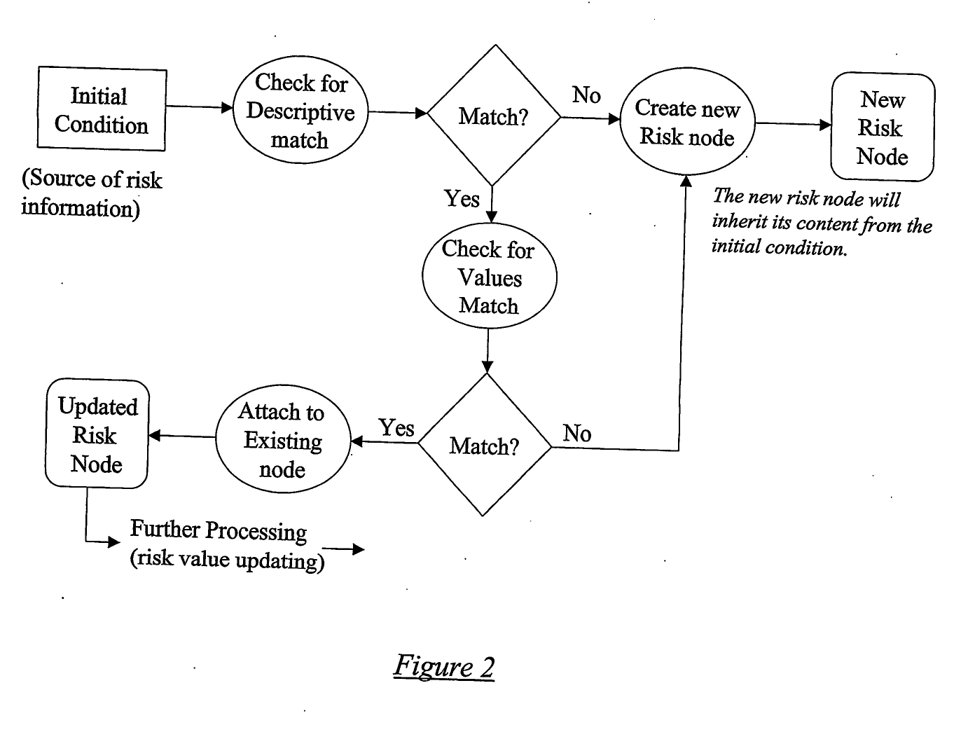

FIG. 2 shows a functional flow diagram of how a risk node is created or how an existing risk node has a second or subsequent initial condition associated therewith. Here, data of a risk is processed to provide a descriptive title, an impact value and a likelihood value. The descriptive title may have three subsets as described previously and this will be explained in due course. FIG. 2 functionally shows that the data representing the risk information has a potential initial condition for a possible already existing node. Accordingly, a process of checking for a descriptive match of the titles of the new initial condition and the title of the risk initial condition for an existing node occurs. If there is no match, then a new node is created as a further risk event. This new node will then inherit its descriptive title, its impact value, and its likelihood value from the initial condition of that risk.

If there is a match with the descriptive title, then a check is made of the values of the impact value and likelihood value to see if there are matches with those of the initial conditions already existing for the node for which there is a title match. If there is no match of the impact value or treatment value, even though there has been a match of the descriptive title, then a new node is created inheriting the impact values and likelihood values from the new risk information.

If, on the other hand, there is a match of one of the impact values, or the likelihood values (and not a match of both the impact value and likelihood value) then that new risk is associated with the existing node as a further set of initial conditions. Accordingly, the risk node is then updated with an associated initial condition so that the risk node then has two initial conditions.

If the impact value and likelihood value both match then the existing node is not changed by a further associated initial condition, and neither is a new node created.

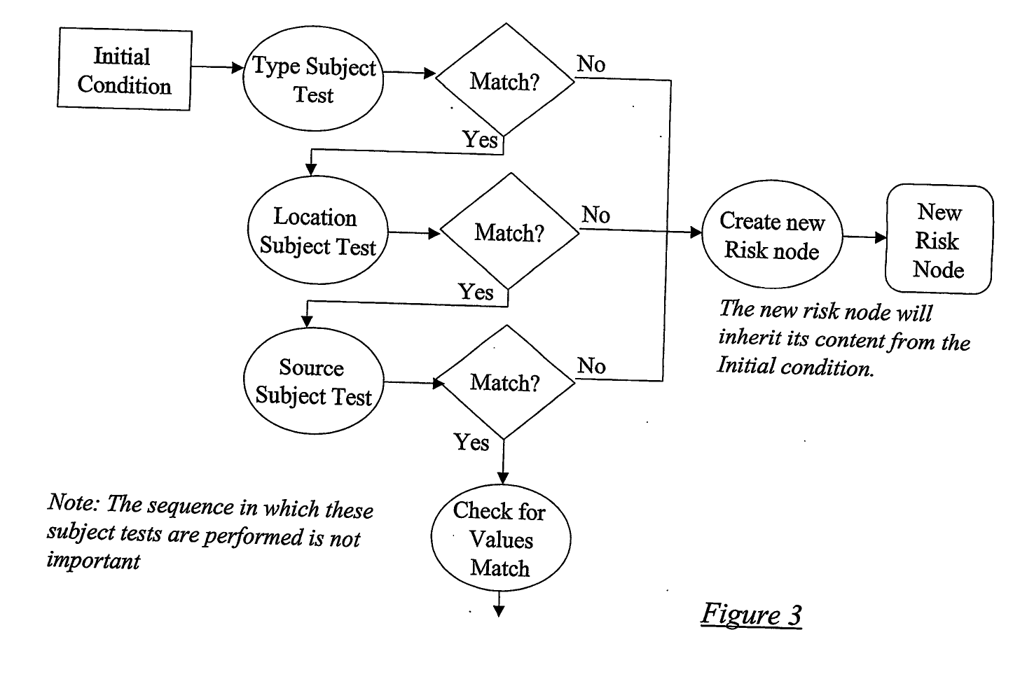

Referring now to FIG. 3, there is shown a functional flow diagram of how a descriptive title is broken down into subsets and how a match is determined for further processing in the system shown in FIG. 2. FIG. 3 clearly shows that initial condition has a descriptive title comprised of:
(i) TYPE;
(ii) LOCATION; and
(iii) SOURCE
   The TYPE of the event is information about the nature of the event. For example, a risk of “power failure” has a specific meaning, which refers to the loss of electrical power to some aspect of the organisations operation. Therefore, the classification of “power failure” is different and has a different meaning to the type of event identified by “raw material disruption”, which may be defining a potential problem with the acquisition of raw material. Further, the definition of “major power failure” could have a different meaning to “power failure“, if the word “major” is inferring a different qualitative or quantitative value from just “power failure”. Accordingly, the TYPE in the descriptive title is risk information that applies to initial conditions.

LOCATION refers to a specific point in the organisations sphere of operation and vision. This location can be either a physical or logical location. For example, “power failure at systems control” refers to a specific location. That is the systems control department, which may be housed in specific building. “Power failure at company ABC” has a different meaning again. Accordingly, even though “system control” may be within company ABC, the location is different because it represents something different from just system control.

SOURCE refers to a source that is creating the risk or example, “power failure at systems control from weather extremes” may be stating that bad weather is the source of power failure risk in this case. This could be high winds, heavy rain, etc, as this may cause the power cables to break. Accordingly, “power failure at systems control through local fauna activity” is different from previous examples because it is representing a risk from local wild life such as rodents, which may eat the power cable insulation. Accordingly, by defining the descriptive title with TYPE, LOCATION and SOURCE, then an accurate description of the content of the risk event may be obtained.

The system shown in FIG. 3 checks for a descriptive match; it tests for TYPE, LOCATION and SOURCE as shown in FIG. 3. If any one of those three descriptive title subsets does not result in a match, then a new node is created, and that new node inherits the descriptive title and the impact value and likelihood values of that particular initial condition. If there is a match however, then the process outlined in the flow diagram of FIG. 3 continues.

By observing FIG. 3, it can be seen that potentially new risk information is received as an initial condition and is checked for descriptive title match and for matching values of the impact value and the likelihood value for that particular risk. In other words, the potential new risk initial condition information is compared with the initial conditions established at various nodes. Accordingly, after a title match is determined and one or more nodes selected because of the title match, then the impact values and likelihood values of each of the associated initial conditions, is then checked for a match. In this process, a match is required with either the impact value or the likelihood value of an already attached initial condition at a node.

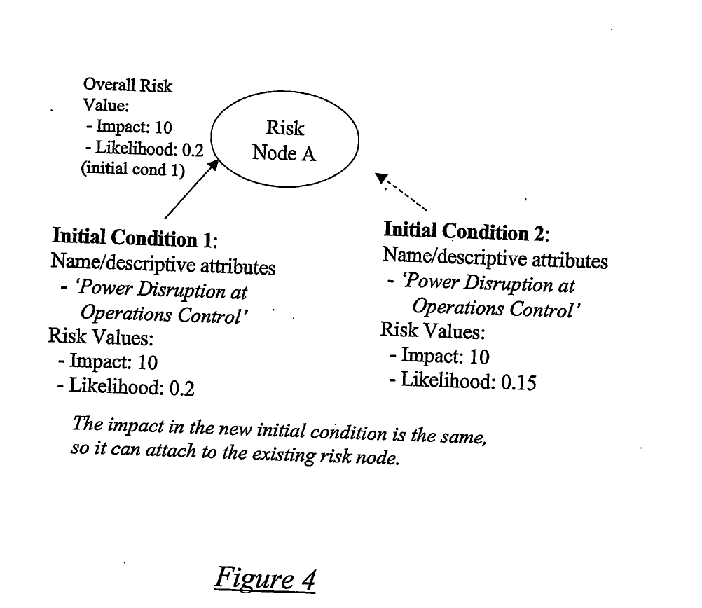

FIG. 4 shows a risk node representing risk A which has an initial condition 1 attached thereto. A potential new risk represented by an initial condition is then checked and in the case shown in FIG. 4, there is a match of the impact values (where each of the impact values is shown by numeral 10). Accordingly, the new or second initial condition can then attach or be associated with the existing node together with the initial condition 1.

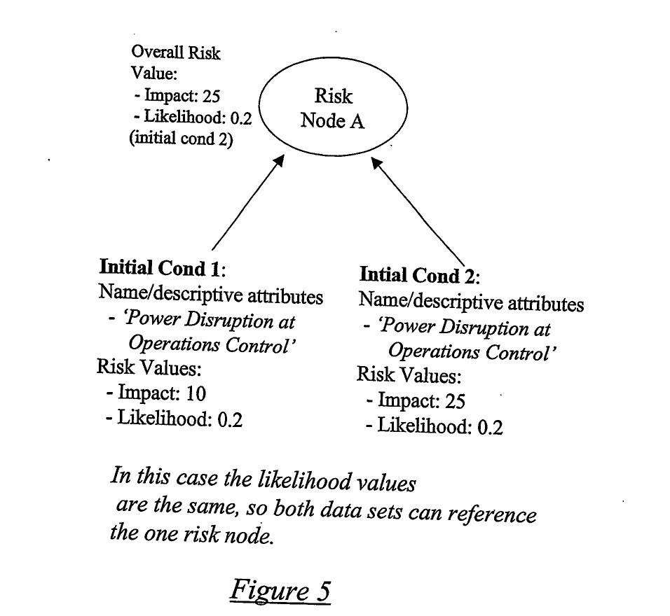

FIG. 5 shows a further example but, in this case, the likelihood values match and are represented by numeral, 0.2. Accordingly, the risk A at the node then has two initial conditions associated therewith.

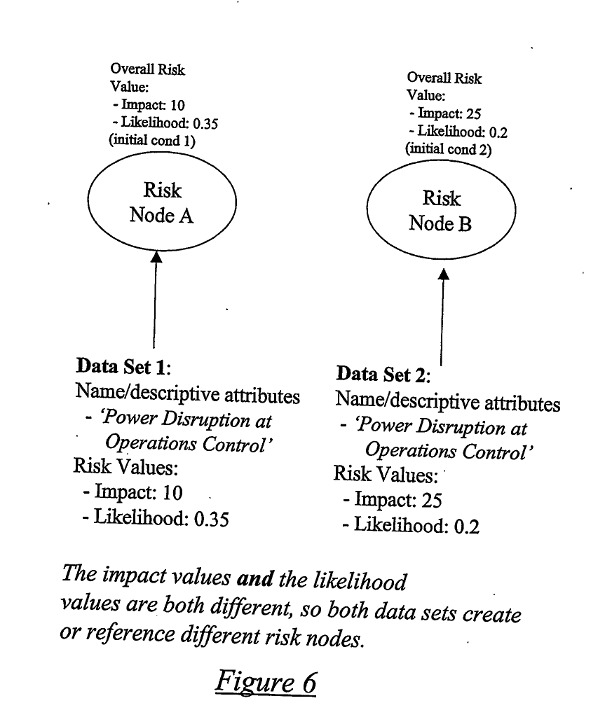

FIG. 6 shows an arrangement where two separate risk nodes are provided—for risk A and risk B. This occurs because neither the impact values or the likelihood values match.

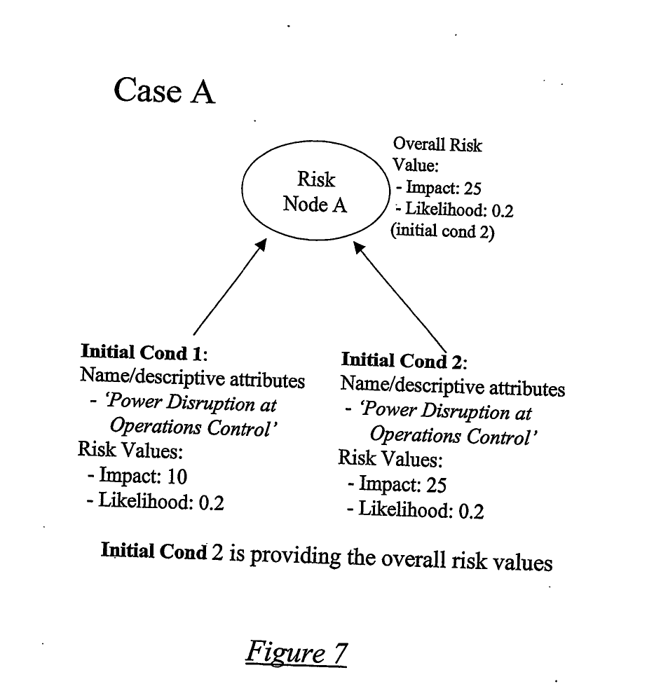

FIG. 7 shows a further example at a risk node where the likelihood values match but where the overall risk value takes on the value of the impact values for initial condition 2.

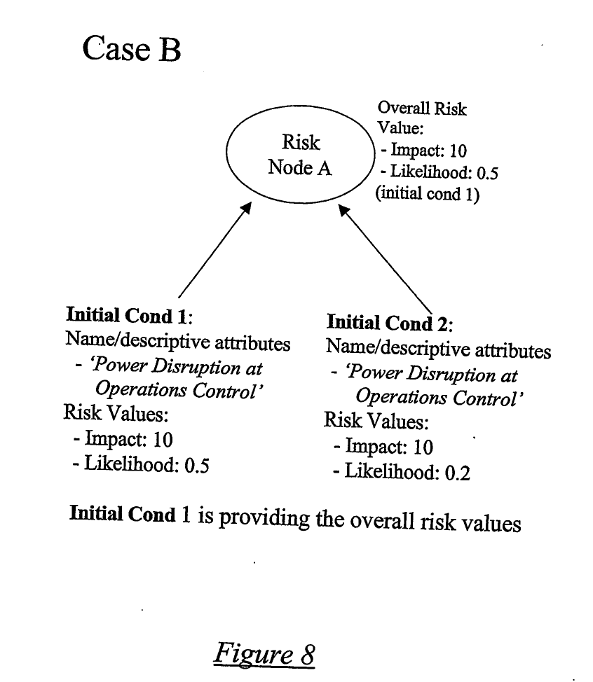

FIG. 8 shows situation similar to that of FIG. 7 except that in this case the impact values match and the overall risk value at the node takes on the likelihood value of initial condition 1.

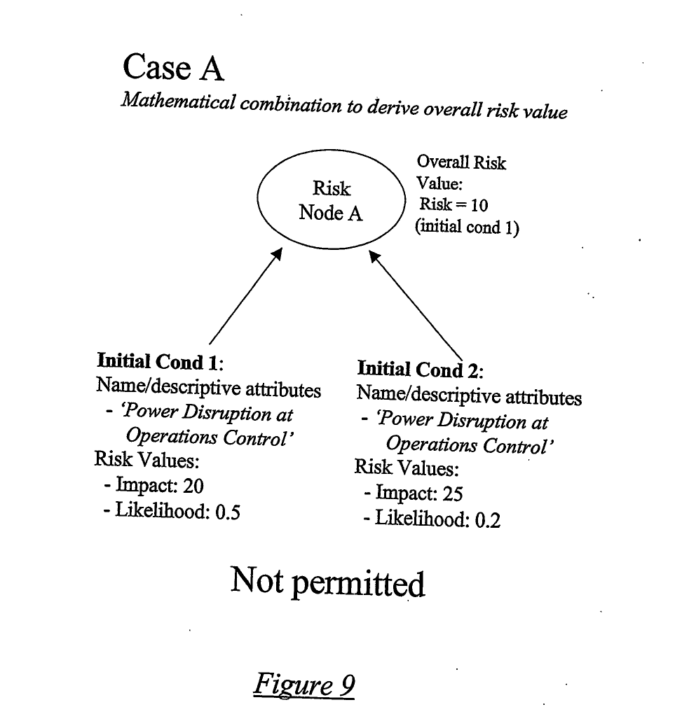

FIG. 9 shows a mathematic combination arrangement that is not permitted in the system.

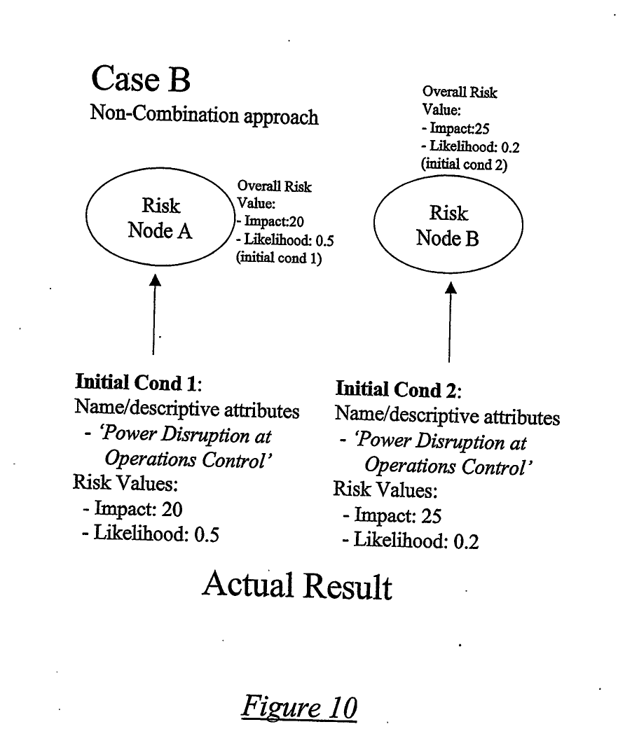

FIG. 10 shows the situation that occurs in the example, with a non mathematical combination approach. Here, it can be seen that whilst the descriptive titles match, neither the impact values or the likelihood values match. Accordingly, separate nodes are provided for each of risk A and risk B.

The preceding discussion has assumed that a node has only one initial condition attached thereto, and that a potential new risk could be associated with the node as an initial condition 2. If however, the node already has associated with it an initial condition 1 or an initial condition 2, and a further possible new risk is processed and there is a match of the descriptive titles, then there may be a slightly different outcome as explained hereinafter. In this case, with a node having two or more initial conditions and the possibility of a third initial condition attached thereto, there can be two or more results that occur.

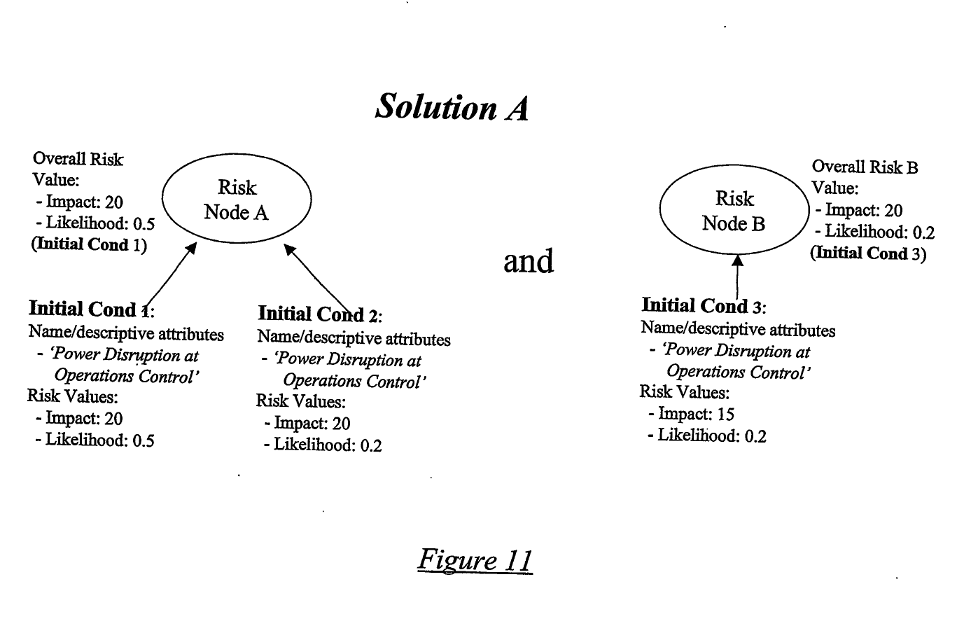

FIG. 11 shows a first solution A in this case. Here a node, being for risk A is shown with an attached initial condition 1 and an attached initial condition 2. A third initial condition is attempted to be added. In this case for the initial condition 1, there is an impact value of 20 and a likelihood value of 0.4. For initial condition 2 there is an impact value of 20 and a likelihood value of 0.2. For the initial condition 3, there is an impact value of 15 and a likelihood value of 0.2. Accordingly, the likelihood value of initial condition 2 corresponds with the likelihood value of the new risk represented by initial condition 3, but these do not correspond with the likelihood value of 0.5 of the initial condition 1. Accordingly, a solution is provided in this matching process to provide a new risk B, with a new node which has an attached initial condition 3 as its sole initial condition.

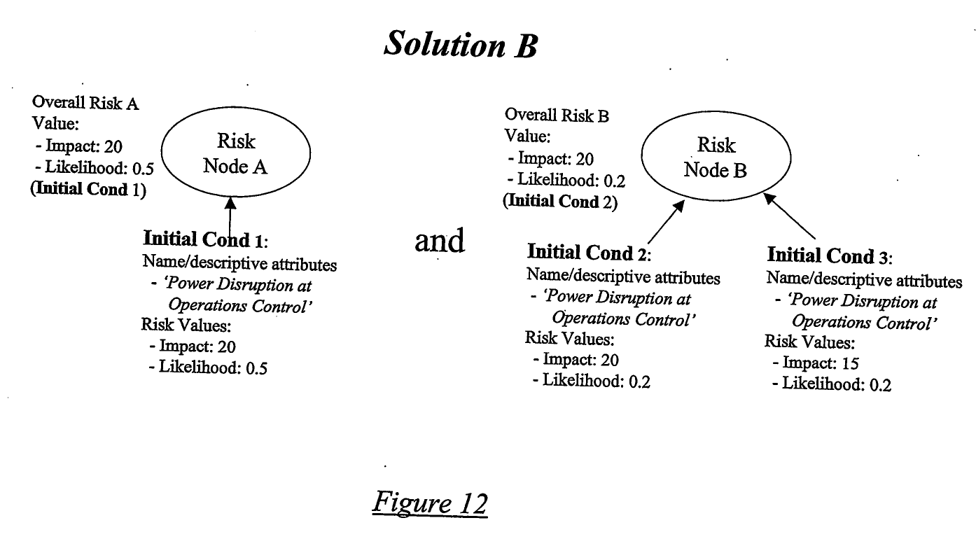

FIG. 12 shows a solution B for the same sets of initial condition 3. Here, the risk A is represented by initial condition 1 and initial condition 2 as described in FIG. 11. When initial condition 3 is compared and matched, then it matches only with a likelihood value of 0.2 for initial condition 2. Accordingly, in this scenario, initial condition 2 is separated from the node representing risk A, and attached or associated with a node newly created for risk B. This new node therefore has associated with it, initial condition 2 and initial condition 3. The node representing risk A is then represented only by the initial condition 1.

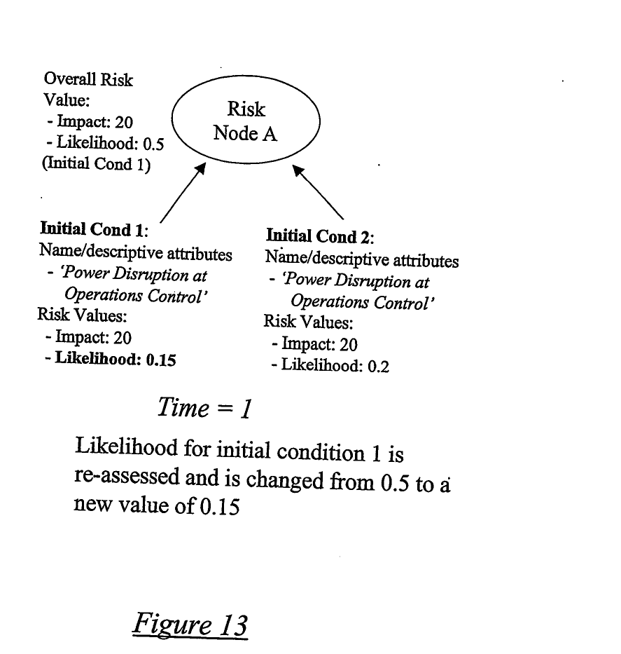

Initial condition risk values may change over time. For example a further assessment of a risk environment can produce an update of risk value results. This is represented by FIG. 13 which shows that at time=1, risk node A has an overall risk value with an impact value of 20 and a likelihood value of 0.5 which it has inherited from initial condition 1. Also, at time=1, initial condition 1 has had its value for likelihood changed from 0.5 to 0.15.

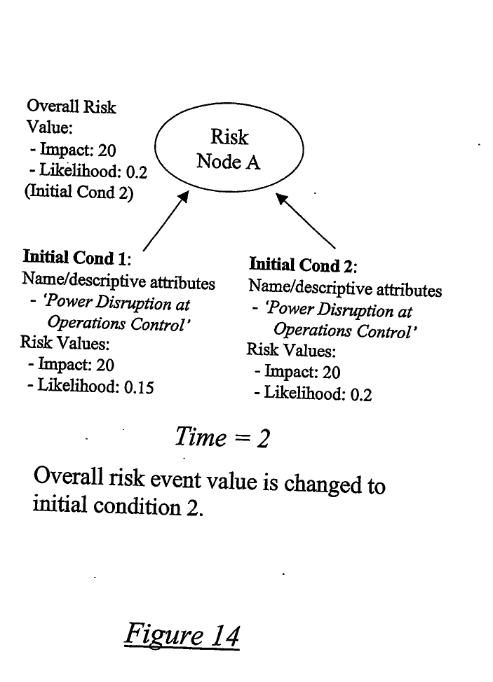

FIG. 14 shows that at time=2, because the initial condition 1 value no longer produces the highest overall value for the risk node, the overall value of the risk node also changes so that it takes the value from initial condition 2.

As explained previously, a treatment can only attach to an existing risk node. Therefore, a treatment is targeted to a specific node or nodes and the treatment can treat any of the risk values eg. impact or likelihood.

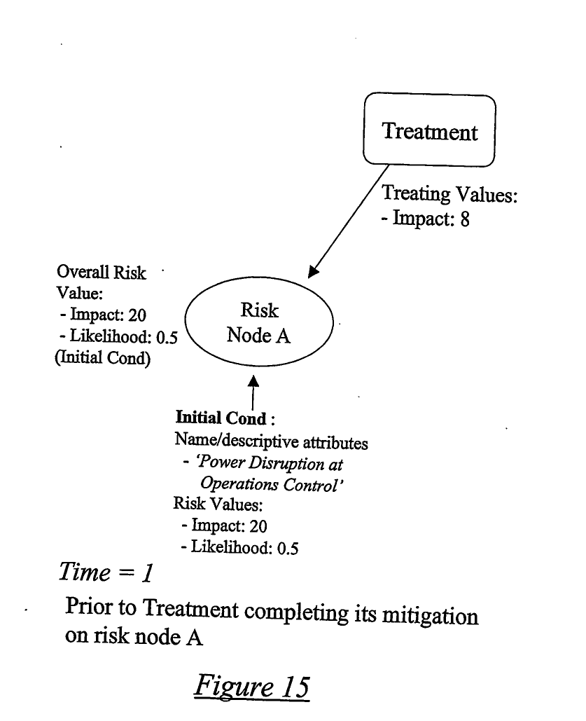

FIG. 15 shows how a treatment can be associated with a particular risk node. In this case, the treatment represents treating values for impact values only. In this case, the treating values is 8.

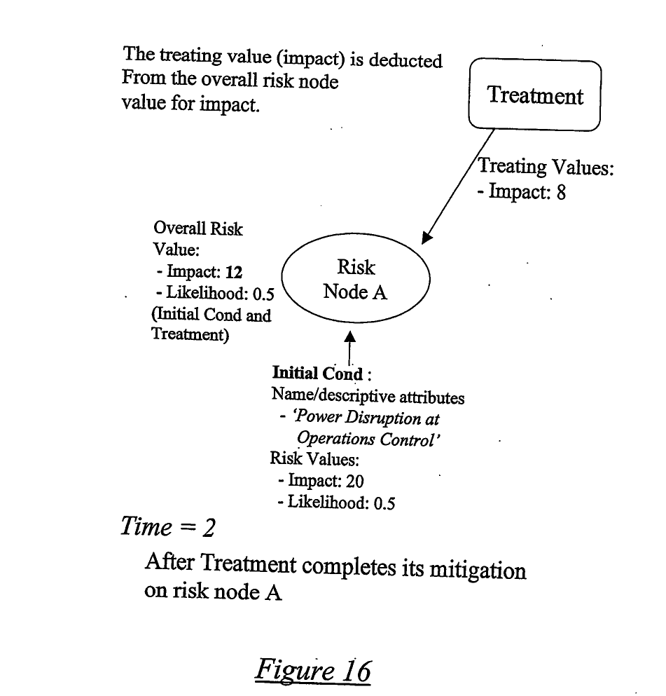

FIG. 16 shows the overall risk value changed for the node with a new impact value of 12 but with a likelihood value of 0.5 being the original likelihood value. Accordingly, in this example, the treatment only affects the impact value, and the impact value assumed for the overall risk is the difference between the initial condition attached to the risk node and the treating value.

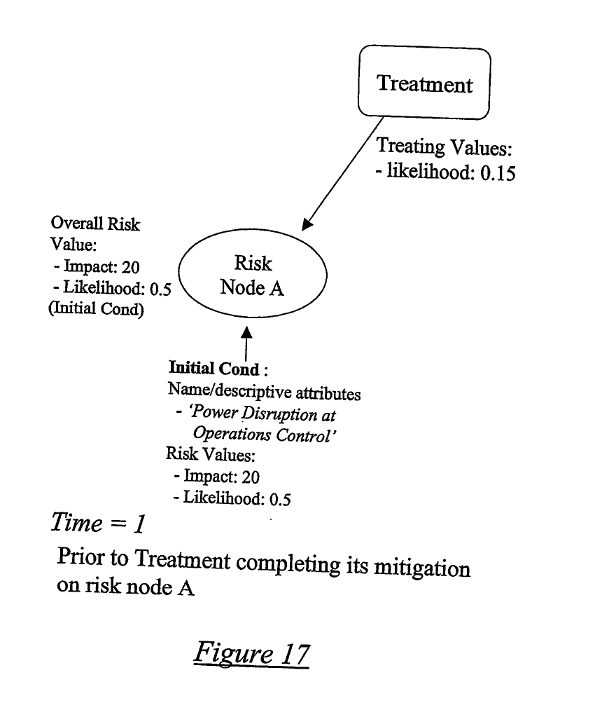

FIG. 17 shows a treatment representing a treatment for the likelihood only where the treatment likelihood value is 0.15. In this case, the overall risk node value has an impact value of 20 and a likelihood value of 0.5.

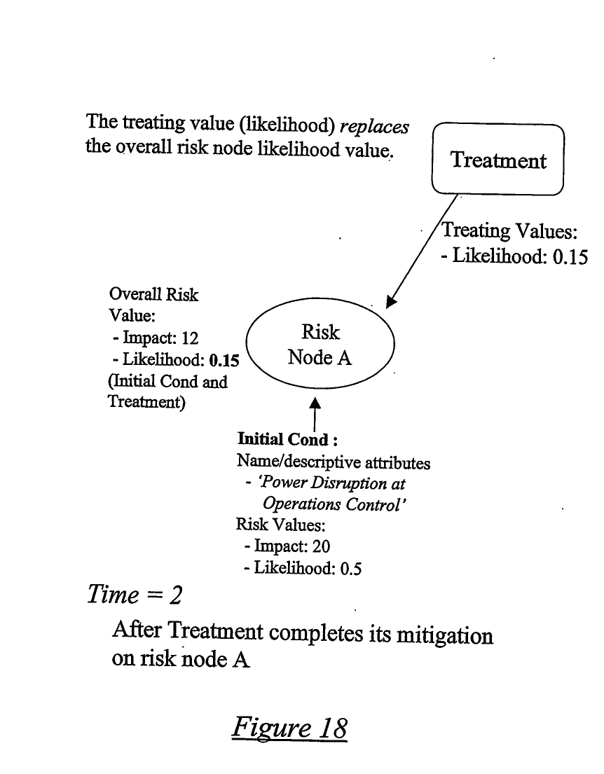

FIG. 18 shows the arrangement after the treatment has occurred and mitigated the risk represented by the node. In this case, the treating likelihood value is 0.15 and that treats the likelihood value of 0.5 of the initial condition associated with the node. Accordingly, the overall risk node value is changed to have an impact value of 20 (being the original impact value), with a changed likelihood value of 0.15.

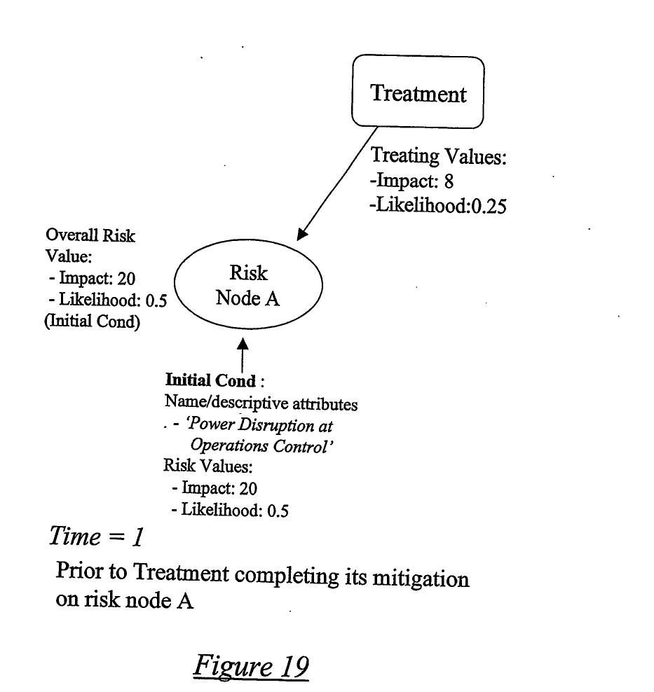

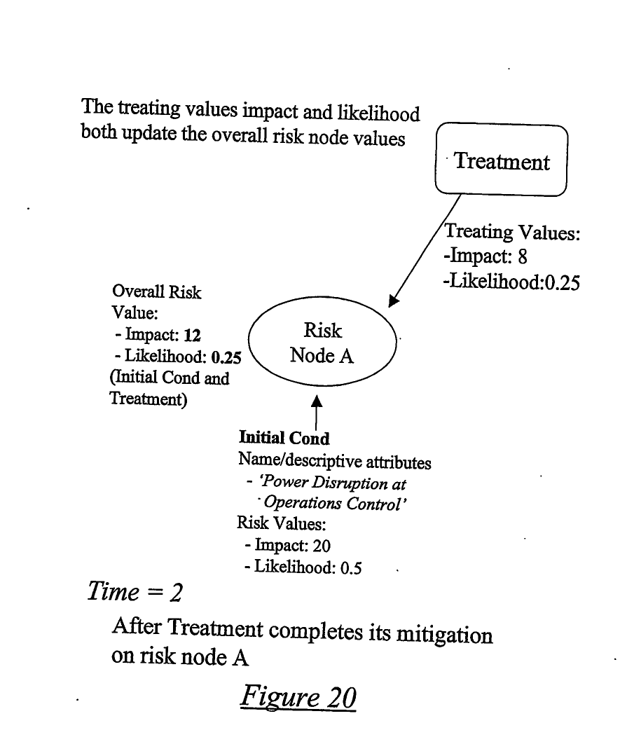

FIG. 19 shows a treatment that treats both impact values and likelihood values. In FIG. 19, the overall risk value is shown having an impact value of 20 and a likelihood value of 0.5. After the treatment occurs, there is a changed condition shown by FIG. 20 where the overall risk value has an impact value of 12 and a likelihood value of 0.25.

Accordingly, it can seen that the impact value of the overall risk is represented by the difference between the initial condition impact value and the treating impact value. The new likelihood value then assumes the likelihood value of the treatment rather than the likelihood value of the initial condition 1. Thus, the new likelihood value is the likelihood value of the treatment, whereas the new impact value is the difference between the initial condition impact value 20 and the treating value 8, which shows a new overall risk event value having an impact value of 12.

Multiple treatments can also be applied to nodes simultaneously.

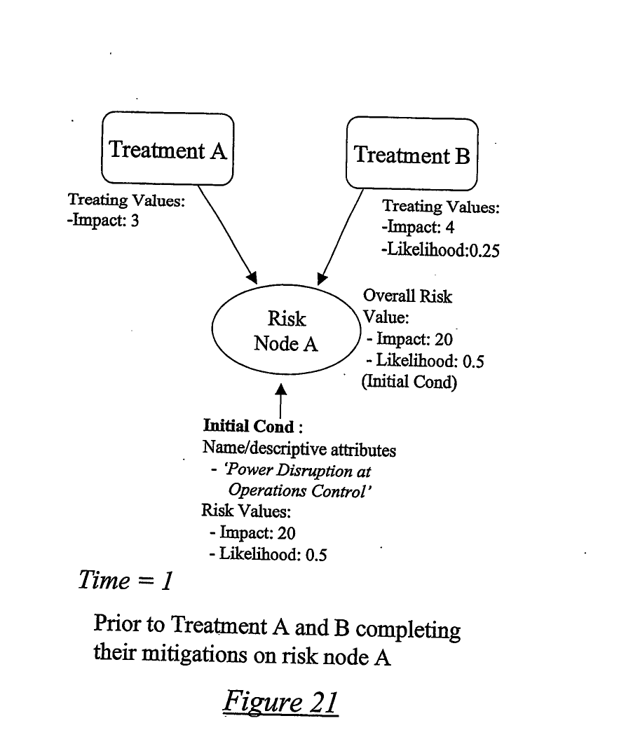

FIG. 21 shows a risk node with treatment A and treatment B. The overall risk value of the node for the risk event is impact value 20 and likelihood value of 0.5.

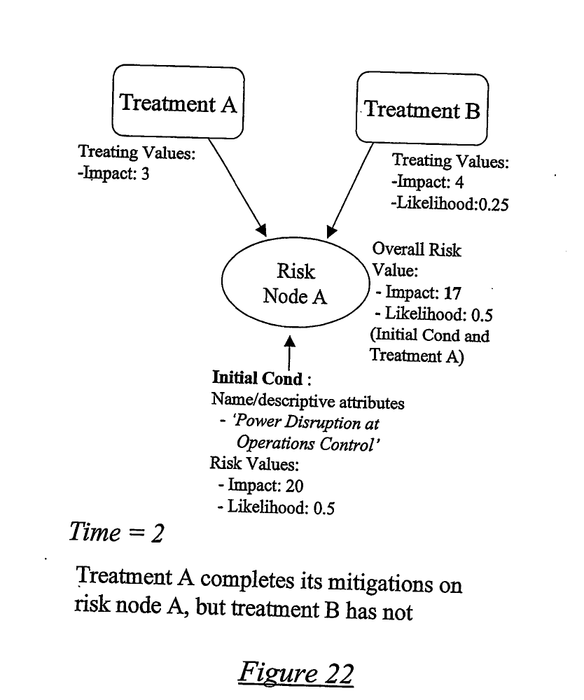

FIG. 22 shows the results after treatment A completes its mitigation and prior to treatment B being effected. Here, the overall risk value is changed to have an impact value of 17 with a likelihood value of 0.5. Again, the new overall risk value, having an impact value of 17, represents the difference between the original impact value 20 of the initial condition for the risk event node and the treating impact value 3.

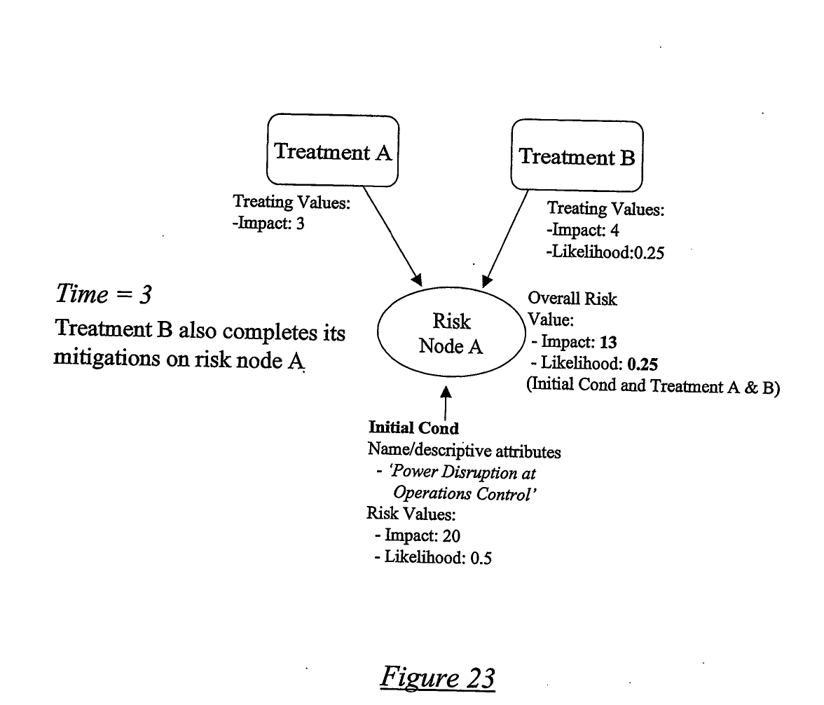

FIG. 23 shows the results after treatment B has completed its mitigation on the risk A. It should also be noted that treatment B treats impact values and likelihood values. In this case, after treatment B has occurred, the overall risk value has an impact value of 13 and a likelihood value of 0.25. In this case, the node, having had treatment A applied thereto, has an impact value of 17 and a likelihood value of 0.5 as shown in FIG. 22. After application of treatment B, the overall risk value has an impact value of 13, being the difference between the treating impact value 4 for treatment B and the overall risk value having an impact value of 17. In addition, treatment B treats likelihood values as well, and in this case, the new likelihood value represents the value of the treatment.

It should be appreciated that treatments can have multiple phase levels, and that each phase level can also potentially have mitigating effects on a treatment which can be measured and tracked for the risk event. Multi phase level treatments can take two forms being either sequenced or non-sequenced treatment.

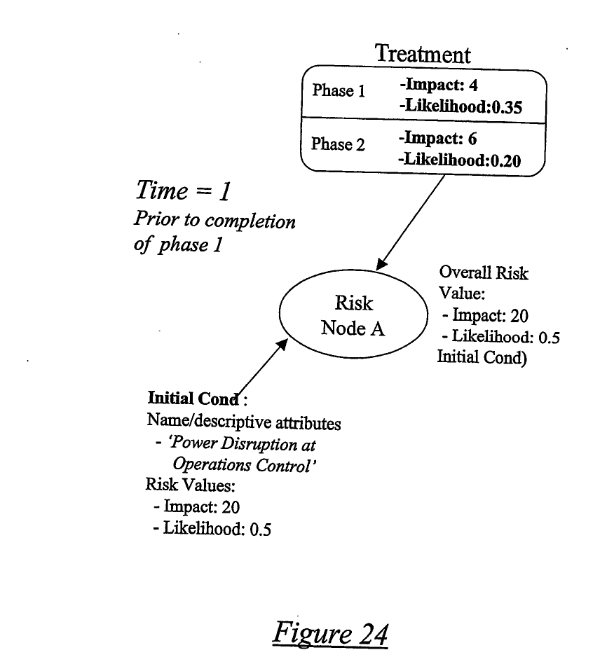

A sequenced treatment could represent a project having several key phases. Each phase, once completed, will then take some predetermined mitigating effect on the overall risk event values. This incremental effect can be captured through a sequenced treatment model on the overall risk event, and it is shown in FIGS. 24, 25, and 30. FIG. 24 shows a risk node for a risk A with an attached or associated initial condition. There are two phases of possible future treatments shown in FIG. 24.

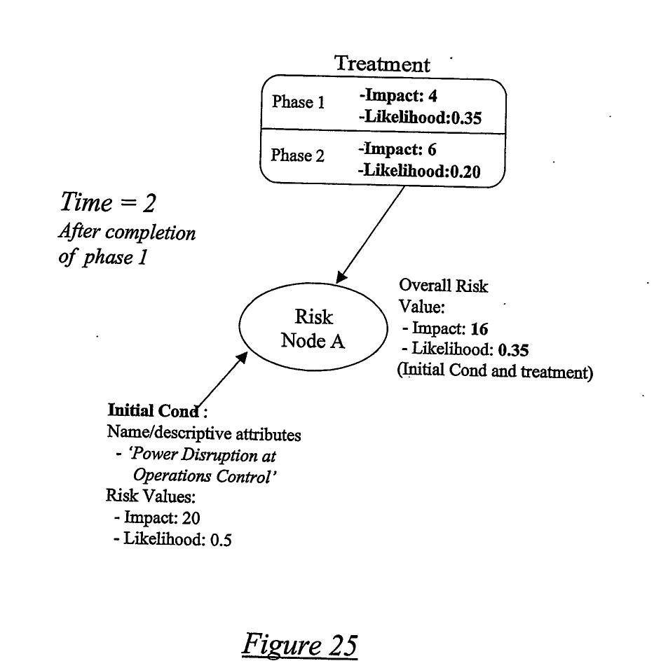

FIG. 25 shows the treatment after phase 1. Here, phase one has an impact value of 4 and a likelihood value of 0.35. The initial associated condition has an impact value of 20 and a likelihood value of 0.5. In this case after completion of phase one treatment, the overall risk value for the node is changed to an impact value of 16 and a likelihood value of 0.35. Accordingly, the impact value for the overall risk value is represented by the difference between the previous impact value 20 and the treatment phase one impact value of 4. Accordingly, the overall risk value of the impact value is changed to 16. The likelihood value of 0.35 for the overall risk assumes the likelihood value of the phase one treatment.

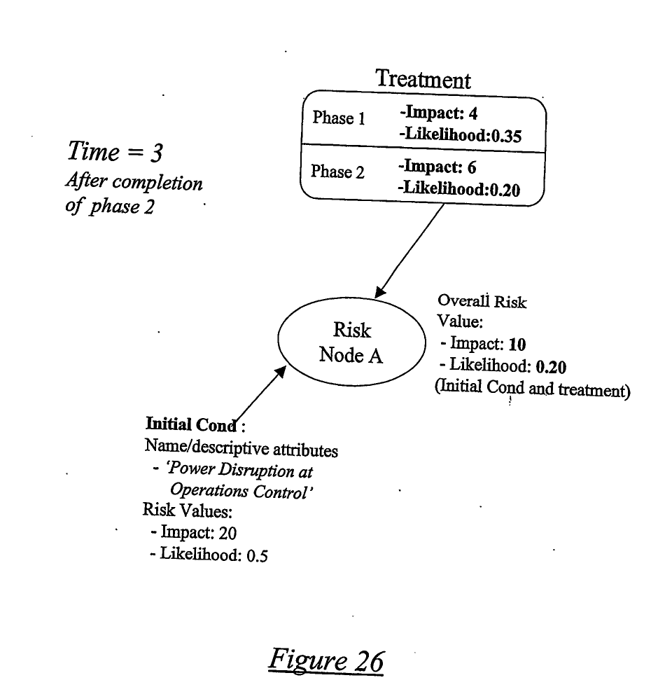

FIG. 26 shows the situation after completion of phase two. Here, the overall risk value has changed to an impact value of 10, being the difference between the impact value for the overall risk, shown in FIG. 25, of 16, and the phase two impact value of 6. In other words, the new overall risk impact value is 10. The likelihood value then changes to the phase two likelihood value. In other words the treatments are cumulatively adjusted with each phase so the overall risk value of the node is cumulatively adjusted.

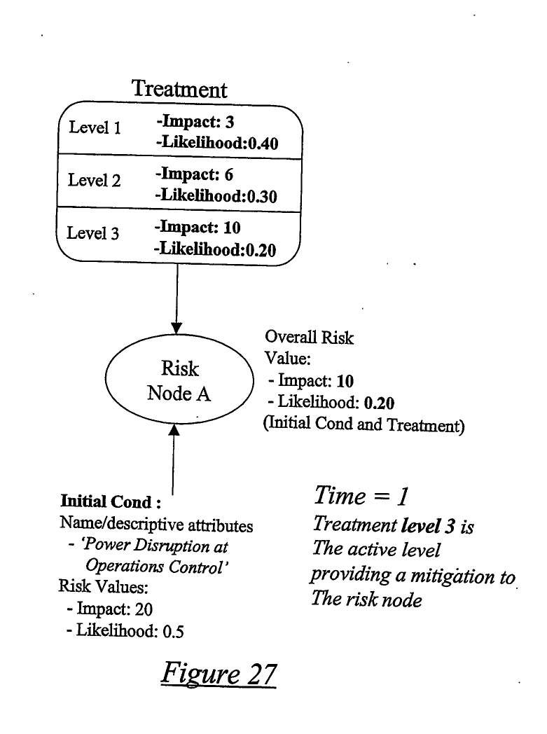

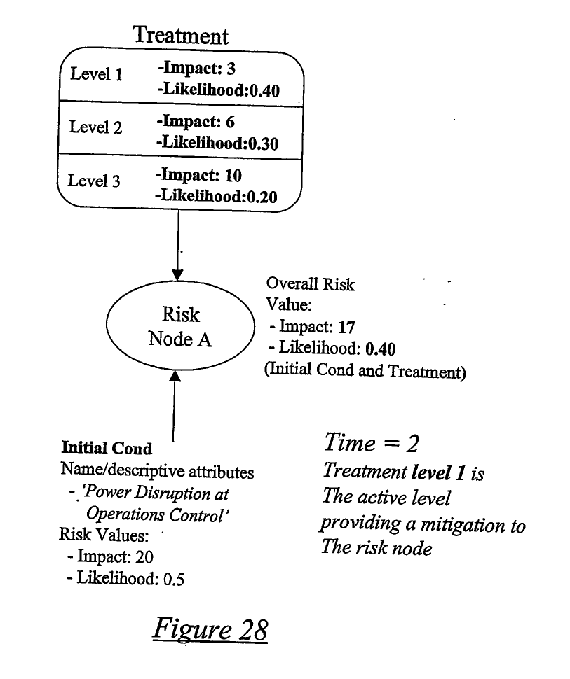

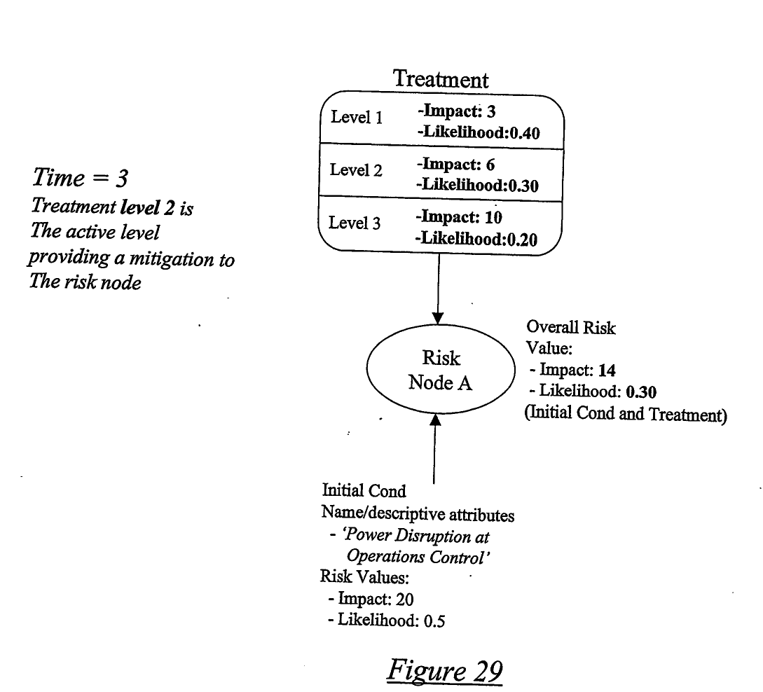

Non-sequenced treatments are shown in FIGS. 27, 28 and 29. Non-sequenced treatments represent treatments that can occur or manifest themselves at any time and don't follow any predetermined sequence. For example, a maintenance treatment activity of a risk may have several known states (levels) each of which will have a certain treating effect on the risk. Only one level will be active at any point in time. The rule previously explained for the adjustment of the overall risk values is again followed. For non-sequenced treatments, the overall risk value of the node is adjusted to assume the risk value of the phase of the treatment.

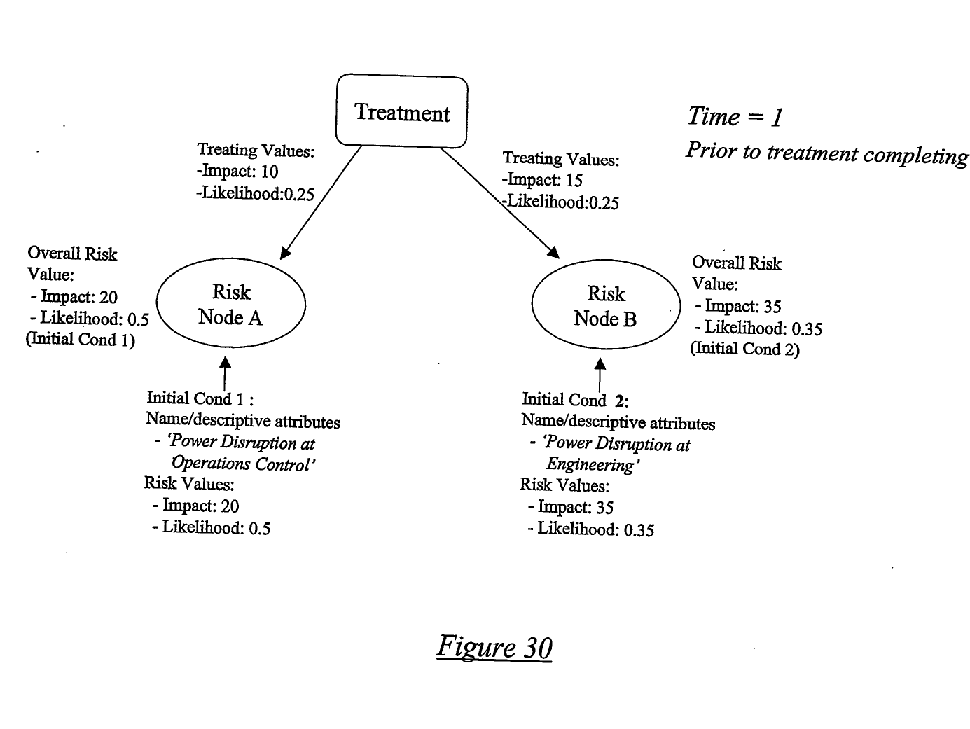

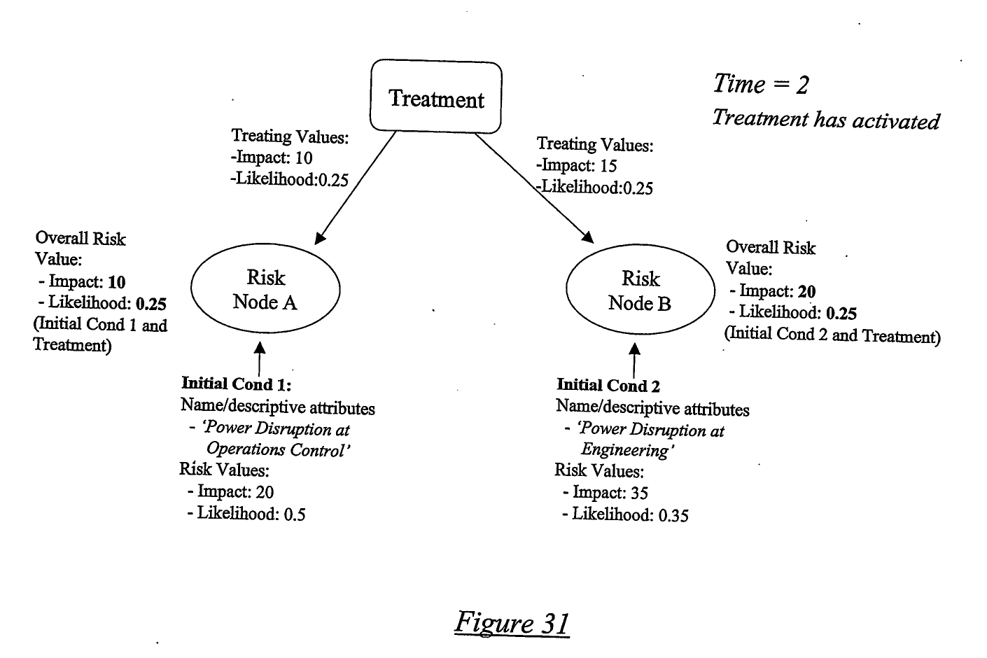

Treatments can occur to several risks and are not confined to single risks or single nodes. This is depicted in FIGS. 30 and 31. Again, the previously stated rules are changing the impact values and the likelihood values. The treating effects from the treatment can be different for different nodes. FIG. 30 shows that for risk node A, the treating values are 10 for impact and 0.5 for likelihood, whereas for risk node B, the same treatment will have a different treating affect, i.e. a treating impact of 15 and a treating likelihood of 0.25. FIG. 31 shows the results of the treatment effect on each of the risk nodes in accordance with the previously stated rules.

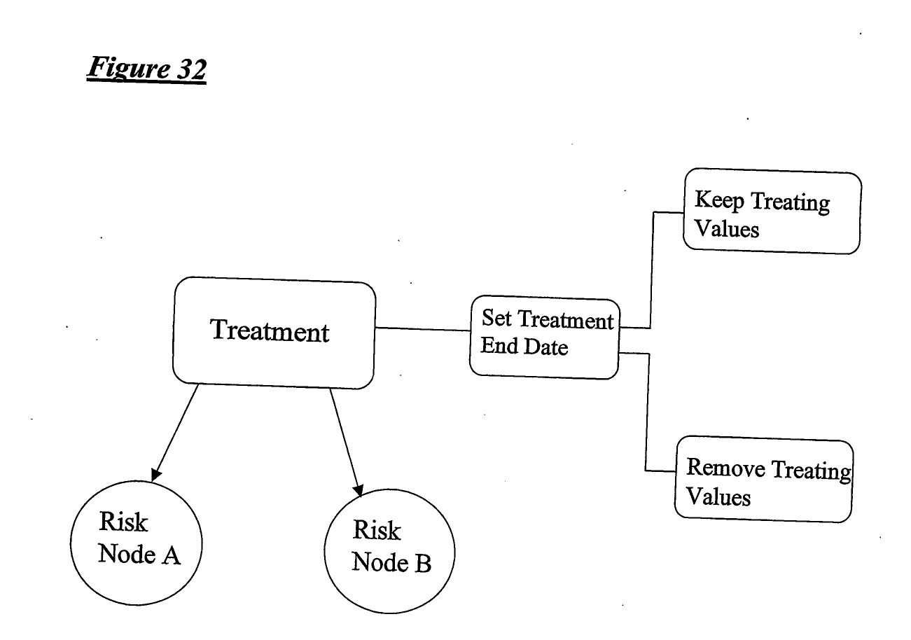

FIG. 32 shows a further option that can be set with regard to a treatment. Here, a treatment END DATE can be set so that a date can be specified at which the treatment will cease for a risk node. FIG. 32 also shows that two further treatment settings can be applied at the end date. A first setting is to keep the treatment values that are applicable at the time the treatment ends. If this option is chosen, then the treating effects are absorbed into all of the conditions attached to the risk node. Therefore, the overall risk node values remain the same as if the treatment is still attached but the treatment itself has been removed. From then on, the values of the node can be changed as described previously. If the removed treating values option is chosen, then once the treatment end date has passed, the treating effect on the risk node is removed, and the risk node returns to an overall risk value that is determined by the attached initial conditions at that time and as described previously.

A choice of options is available with the “location” subset of the descriptive title of a node. As set out above, a risk node is defined through three descriptive subsets being:
1. TYPE
2. LOCATION
3. SOURCE

A location subset requires a choice to be made between two options so that the option can be associated with the “location”. These options are:
1. Exclusive to this location. Here the risk node is only associated with this location.
2. Include all subordinate or link locations below it. In this case the risk node is associated with this location, and all other locations that are subordinate will be embraced.

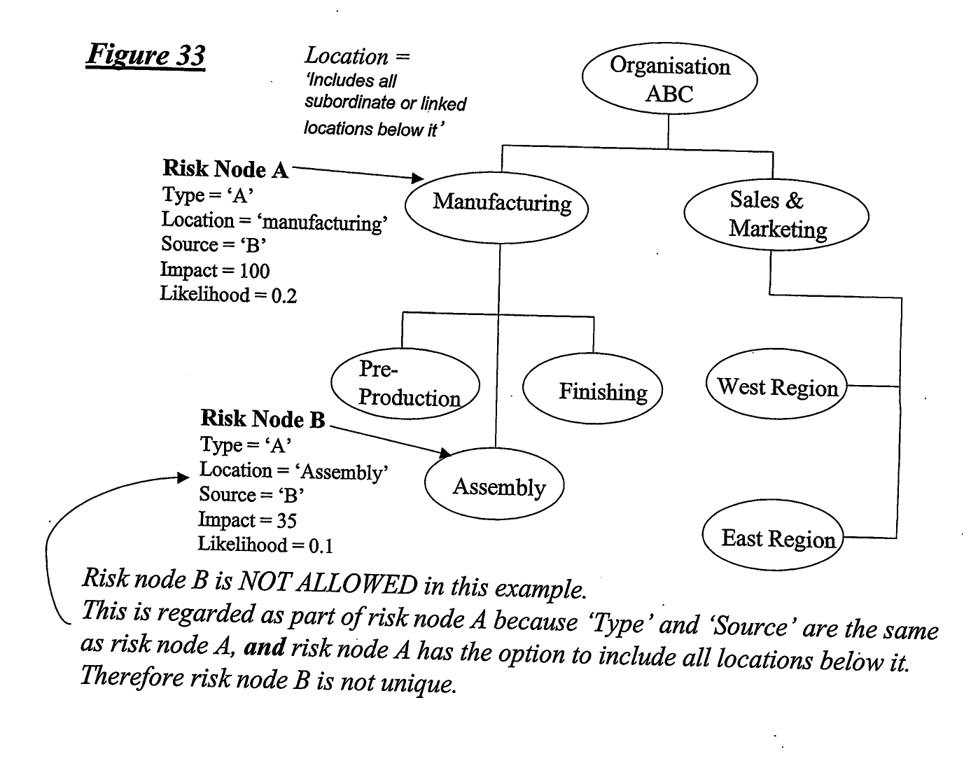

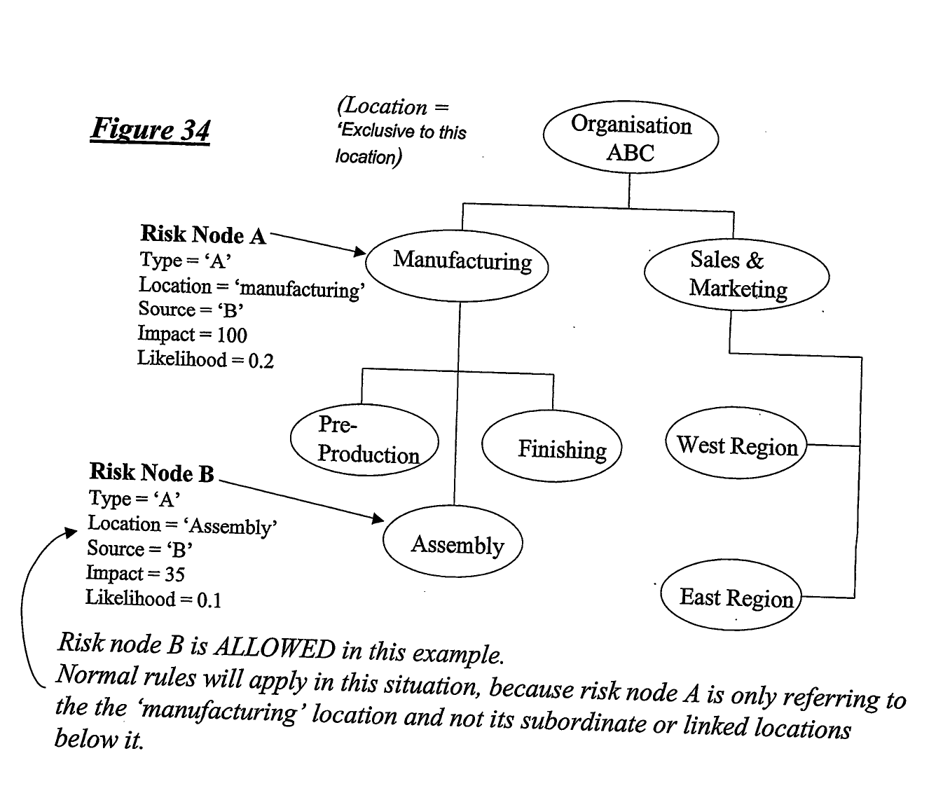

If the first option is chosen—exclusive to this location—then the rules previously described for the node still apply. If the second option is chosen—include all subordinate or link locations below it—then additional rules for defining uniqueness of a risk node apply. FIGS. 33 and 34 show these options functionally. FIG. 33 shows that a potentially new risk node B cannot be allowed because it will be regarded as part of risk node A, because the “type” and “source” are the same as risk node A, and risk node A has been set to the option to include all the subordinate or link locations below it. Thus, any locations that are subordinate or linked will not be tested for uniqueness on either its “location” subset or its risk value. A test for the uniqueness will only be established through the “type” subset and the “source” subset as described previously. Therefore, if a risk node B is attempted to be defined at a location below a risk node A that has been set to the second option to include all subordinate locations or link locations, and the “type” subset and the “source” subset are the same, then the new node B will not be regarded as unique and its creation will not be permitted.

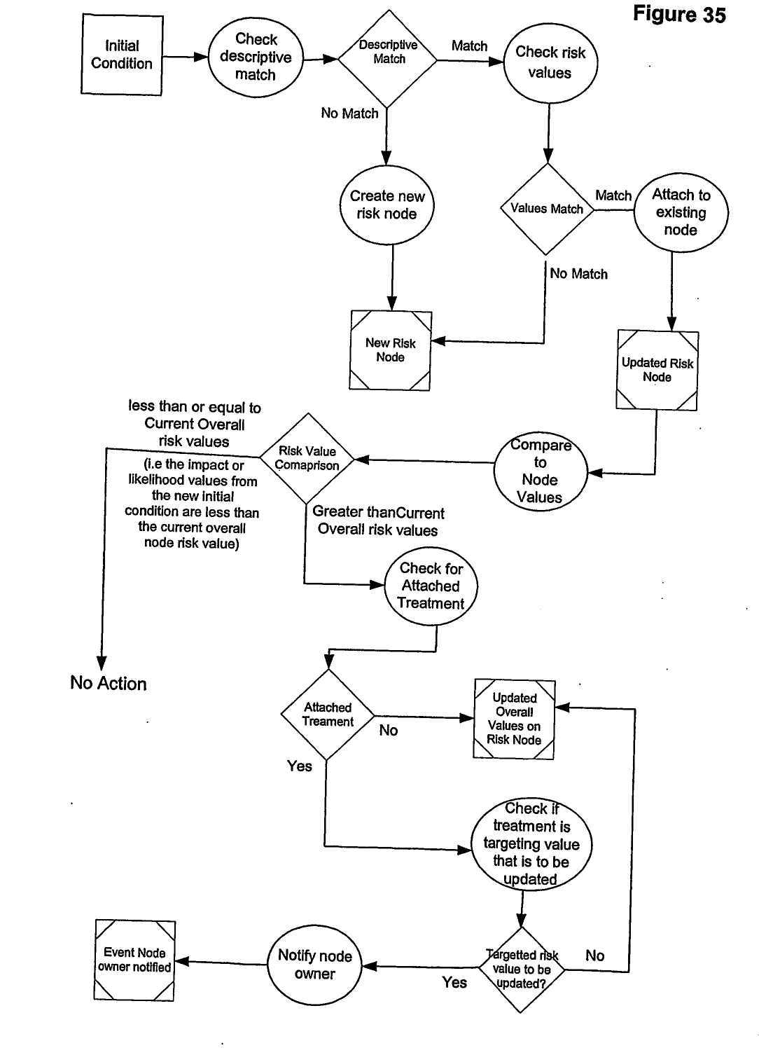

FIG. 35 shows a high level functional flow diagram for the creation of risk nodes from initial conditions and the process for handling updates to risk node values when a treatment is already applied to the risk node.

FIG. 35 shows that if an existing risk node has a new initial condition attached, and through a comparison of that initial condition's risk values with the risk node's overall risk values it is found that the initial condition's risk values are greater, then the overall value of the risk node will require updating. However, before this can be performed a check is performed to determine if a treatment is currently applied to the risk node. If there is a treatment applied to the risk node, then the effects of the treatment on the risk node need to be reassessed to determine if the treating effects of the treatment would still be applicable given that the overall node value is to be changed. That is, the attached treatment has been applied to the node and a treating effect (e.g. lowering the impact or likelihood value of the node) has been determined based on the current value of the risk node. Therefore, if the risk node value were to be changed (be it through a new initial condition, attachment or an update to an existing initial condition risk values), then the applied treatment must be re-assessed to determine whether the treating effect will still be valid against the new risk node values, or whether the treatment will need to be removed, modified or left unchanged.

As depicted in FIG. 35, a flag is raised if there is an attached treatment and the overall node values require change. This flag is applied to the risk node to inform the risk node owner/user that the attached treatment needs to be re-assessed to determine if its treating effects are still valid under the changed risk node values. The node owner/user will then decide and apply the appropriate action, at which point the flag is removed.

It should therefore be noted that the above described example processes risks in a particular way and with particular rules, to enable a managed and controllable environment for risk management. The system is dynamic in the sense that it accommodates for multiple node creation and multiple initial conditions that can be associated with one or more nodes. Further, treatments can be applied across the nodes as required.

This approach is designed to allow an organisation to develop perspectives of risk exposure that best fit their current situation within their human system. Rather than attempt to build a pre-defined picture of risk and or specific categories of risk, risks are simply defined by the “descriptive title”, the “risk impact value”, and the “likelihood value”. The “descriptive title” has three sub-sets being (1) Type (2) Location and (3) Source. In other words, as the interactions evolve, and the personnel of the organisation experience different interactions, they can define subtle but critical differences emerging in the material threats to the organisation, as they perceive them.

In the table below a series of risks are shown with different levels of relationship between the risks. In each example, the risks are independent of each other, only the relationship to each other changes.

| Extent of | | | |
|---|---|---|---|
| Relationship | | | |
| Between Risks | Example Identified Risk | | Comments |
| No | 1. | Supply disruption at | There is no relationship |
| Relationship | | Inbound Goods through | between these two risks. |
| | | Transport Strike | |
| | 2. | Power failure at | |
| | | Production Plant B | |
| | | through Weather | |
| | | extremes | |
| Some | 1. | Supply disruption at | There is a relationship |
| Relationship | | Inbound Goods through | through the location of |
| | | Transport Strike | these two risks. |
| | 2. | Power failure at | |
| | | Inbound Goods through | |
| | | Weather extremes | |
| Moderate | 1. | Supply Disruption at | There is a stronger |
| Relationship | | Inbound Goods through | relationship between |
| | | Transport Strike | these two risks. Both |
| | 2. | Supply disruption at | relate to supply |
| | | Inbound Goods through | disruptions at inbound |
| | | Weather extremes | goods. |
| Strong | 1. | Supply disruption at | In this case the |
| Relationship | | Inbound Goods through | relationship is |
| | | Transport Strike | strongest between these |
| | | Rating = ‘Caution’ | two risks. Both relate |
| | | Impact = $100,000 | to a very similar type |
| | 2. | Supply Disruption at | of risk situation, but |
| | | Inbound Goods through | are defining a different |
| | | Transport Strike | size (effects). In this |
| | | Rating = ‘Low Caution’ | case as in all the other |
| | | Impact = $500,000 | above, the risks are |
| | | | unique, only the level |
| | | | of relationship has |
| | | | changed. |

Using the above method for identifying/defining a risk, an organisation is less likely to have material gaps in its picture of the material risks it faces, because a far greater range of organisational personnel will be able capture their own perspectives on risk exposures the organisation faces.

Using the above risk identification will also create the opportunity for a more effective approach to treating risks. A treatment for a risk is some action that is designed to in some way mitigate the exposure to that risk. Therefore, the risk needs to be identified first before a treatment action can be applied to it. If risks for an organisation are defined under the traditional models, then it is likely that there will be many ‘holes’ in the picture of the risks that the organisation faces. Many subtle (but often critical) variations to the risks identified will not be picked up under the ‘coarse’, traditional identifying approaches. Therefore, any treatments designed to target these risks will also be somewhat coarse responses; they can only target what they know.

For example, a treatment designed to target a ‘supplier risk’ (e.g. major disruption to supplies of raw material) will only be able to structure a response that either alleviates a potential disruption with some contingency/work around plan, and/or target the potential source of the threat in an attempt to lower the likelihood of that risk occurring. In this case, the risk is identified rather coarsely, so a treatment will not be aware of say, potential legal implications of a certain type of supplier risk. Nor will the treatment be able to treat the likelihood of a potential problem to, say, the supplier's key provider who might be having difficulties working with our supplier, and therefore cause our supplier problems with production of its goods.

‘Natural conditions’ can be represented in a condition object. For example dealing with a key supplier will have many natural conditions that may generate risks. A natural condition could be the behaviour of the distribution network. Some aspect of the behaviour of the distribution network could be represented in a condition, for example a strike threat. This condition object could then be used to create a ‘risk node’, which is used to define a risk and represent the potential impact to the organisation and likelihood of that impact occurring.

Over time the behaviour of the distribution network will change, the strike threat could become greater or less of a threat. In either case this change in the state of the natural conditions (and therefore the conditions representing them) can be reflected in the states of specific risk nodes (i.e. defined and measured potential effects on the organisation).

Accordingly, treatments can be devised to mitigate these risks in some way (e.g. reduce the potential impact and/or lower the likelihood of the event occurring). Treatments will typically go through a stage of being developed and initiated, through to being fully implemented. For example, a plan is devised to sign up a backup supplier to provide a certain amount of goods in case of a strike in the distribution network. This plan is initiated and it may then take a number of weeks (or months) before the agreements are in place and a new backup network is established.

Once this treatment is implemented, the risks that are being targeted will change in some way to reflect the treating effect of the treatments.

Naturally, the change experienced by the organisation is not limited to these levels. Lets say a change occurs in the behaviour of the main distribution network after the treatment has been initiated, but before it has been fully implemented. For example, the threat of the strike has become far greater (e.g. it has broaden to involve potentially other areas, therefore its end effect could be far greater than first perceived), or far less of an issue (e.g. an agreement has been work out with the unions and dramatically lowered the threat of a strike).

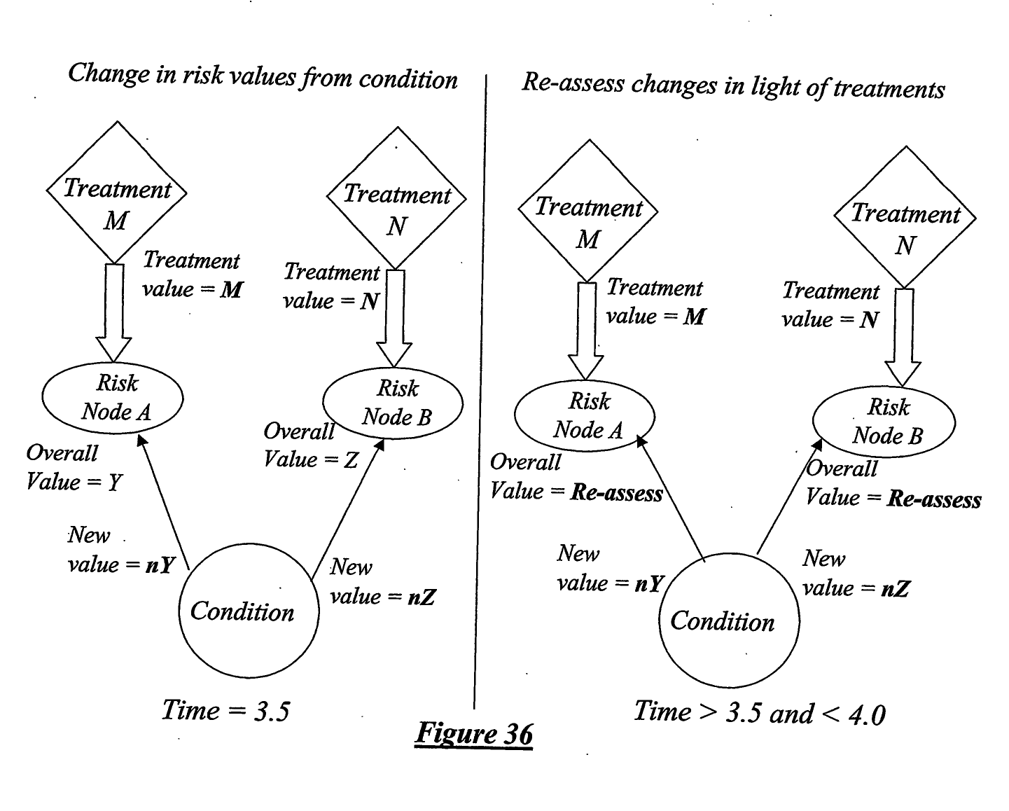

In either case this situation will result in a potential conflict with the current treating program. That is the proposed treatment may now be either inadequate to deal with the new state of the risk situation, or it may be an overkill for the new state of the risk. The basic rules of interaction will in these situations notify the appropriate person(s) about the apparent conflict and request him/her to adjudicate on the appropriateness of the treatment under the new conditions. If the treatments are appropriate, they will continue to perform their functions on the risks they are targeting, otherwise, they may be adjusted, removed, or replaced with some other treating effect that may be more appropriate. This is shown diagrammatically in FIG. 36.

This new mechanism provides the benefit of enabling an organisation to mange and track complex change across many different risks. The organisation can also develop a far more responsive approach to the way it applies treatment actions to mitigate risks. As shown in FIG. 36, the system provides the ability to notify appropriate personnel when a treatment that is being applied to a risk may require a re-assessment.

Typically, the above process is implemented in a software program resident in a computer. The software program may be provided on a data storage medium with a set of operating instructions for the computer program itself. As new risks and/or treatments are perceived, then they can be entered into the computer system so that they interact in the ways described previously.

Modifications may be made to the invention as would be apparent to persons skilled in the risk management art and/or computer arts. For example, the terminology adopted for the various descriptive titles may be changed. The impact values and/or likelihood values may assume different titles. The effect however, for each of these will be the same as described in the terms used should be considered broadly to embrace all such variations in naming.

These and other modifications may be made without departing from the ambit of the invention, the nature of which is to be determined from the foregoing description.

1. A risk management process for identification and tracking of a plurality of risks,
said management process having at least the following steps:
1. defining a risk by providing:
(a) a descriptive title;
(b) a risk impact value; and
(c) a likelihood value
2. setting (a), (b), and (c) as a first set of initial conditions for the risk;
3. establishing a node for the risk with the first set of initial conditions associated therewith;
4. repeating steps 1 and 2 on a possible further risk;
5. determining if the initial conditions obtained in step 4 are identical with the initial conditions of the node established in step 3; and
if the initial conditions are not identical, comparing the descriptive titles and
(i) if the descriptive titles are not identical, establishing a further node with initial conditions determined at step 2 for that possible further risk or
(ii) if the descriptive titles are identical, comparing both the impact values and the likelihood values and
(c) if one of those impact or likelihood values is identical, associating the initial conditions of that possible further risk with the risk node established at step 3 as a further initial condition; and
(d) if neither of the impact values and likelihood values is identical, establishing an additional risk node with the initial conditions for that risk as determined at step 2 for that possible further risk.
Whereby the established nodes permit identification of the risks, and the subsequent tracking of the risks.

2. A process as claimed in claim 1 wherein the process steps are repeated with possible further risks, and step (5) is performed by comparing the initial conditions of the possible further risks with the initial conditions of all nodes that exist at that time.

3. A process as claimed in claim 1 wherein the descriptive title in step (1) is defined by three descriptive title sub sets being:
(i) Type
(ii) Location and
(iii) Source

4. A process as claimed in claim 3 wherein process step 5(ii) requires all three sub sets to be identical, before the step of comparing both the impact values and the likelihood values results in either the association as in step 5(ii)(a) or establishing of a further risk node as in step 5(ii)(b).

5. A process as claimed in claim 1 wherein when one or more associated further initial conditions are established for a risk node, a step of changing the overall risk values in that node is performed so that a changed overall risk value then assumes the risk value of the initial condition that has the higher of the impact value or the likelihood value.

6. A process as claimed in claim 2 wherein if a third risk is attempted to be associated with a risk node and one of the impact values or likelihood values does not correspond with one or both of the established initial conditions for that node, then there is either performed the step of:
establishing a new risk node with the initial conditions for that new risk node being the initial conditions of the third risk, or the step of
disassociating an initial condition of one of the two initial conditions established for the risk node, and establishing a new risk node so that a new risk node has both the initial condition of the disassociated initial condition and the initial condition of the third risk associated therewith, and wherein either the impact values or the likelihood values of those two initial conditions agree with each other for that new risk node.

7. A process as claimed in claim 1 wherein there is also provided the step of re-assessing risk values of an initial condition of a node, said re-assessing then being based on a changed initial condition, and wherein following a re-assessment
(ii) if neither the impact value nor the likelihood value agree with the previous values then establishing a further new node with initial conditions of the re-assessed risk whilst leaving the original risk node with an associated initial condition that has not been changed consequent on the re-assessment.

8. A process as claimed in claim 7 wherein if following re-assessment there is a match of either the impact value or the likelihood value, then the overall risk node value for the node is re-established based on the changed initial condition.

9. A process as claimed in claim 1 wherein there is also provided the further step of applying a treatment to an existing node, said treatment affecting either or both the impact value and/or the likelihood value of the overall risk value of the existing node, and wherein if the treatment is to affect the impact value, causing the resulting impact value to assume a value determined by the difference between the impact value of the overall risk value of that node and the impact value of the treatment,
and wherein if the treatment is to affect the likelihood value, causing the resulting likelihood value of the overall risk value to assume a value determined by the likelihood value of the treatment.

10. A process as claimed in claim 9 wherein there is also provided the further step of providing multiple treatments to a risk node and wherein each treatment follows the rules stated previously for affecting the impact value or the likelihood value of the overall risk value.

11. A process as claimed in claim 10 wherein a single treatment may have multiple levels that may be individually activated.

12. A process as claimed in claim 11 wherein each level may be sequenced within the treatment.

13. A process as claimed in claim 11 wherein each level may be non-sequenced within the treatment.

14. A process as claimed in claim 12 wherein an overall risk value is cumulatively adjusted for the impact value and assumes the likelihood value of the current treatment level.

15. A process as claimed in claim 13 wherein an overall risk value is represented by the treatment values of the current treatment level.

16. A computer system programmed to operate in a way to, in use, perform the process steps recited in claim 1.

17. A memory medium containing computer instruction data that will cause a computer system to be programmed to, in use, operate according to the process steps recited in claim 1.
